(19) United States
(12) Patent Application Publication
(10) Pub. No.: US 2025/0208914 A1
(43) Pub. Date: Jun. 26, 2025

(54) DIRECT POINT-TO-POINT COMPUTING DEVICE BRIDGES

(71) Applicant: Hewlett-Packard Development Company, L.P., Spring, TX (US)

(72) Inventors: Fred Charles Thomas, III, Fort Collins, CO (US); Byron A. Alcorn, Fort Collins, CO (US); Christopher N. Rijken, Spring, TX (US); Charles J. Stancil, Spring, TX (US)

(73) Assignee: Hewlett-Packard Development Company, L.P., Spring, TX (US)

(21) Appl. No.: 18/846,592

(22) PCT Filed: Apr. 11, 2022
(86) PCT No.: PCT/US2022/024215

§ 371 Date: Sep. 12, 2024

(51) Int. Cl. G06F 9/50

(52) U.S. Cl. CPC G06F 9/5027

(57) ABSTRACT

In an example in accordance with the present disclosure, a computing device bridge is described. The computing device bridge includes a first communication port to establish a connection with a first computing device. The first computing device has a first operating system (OS). The computing device bridge also includes a second communication port to establish a connection with a second computing device. The second computing device has a second OS. The computing device bridge also includes a controller. The controller provides a direct point-to-point connection between the first computing device and the second computing device and shares a resource of the first computing device or the second computing device with the other of the first computing device and the second computing device.

### BACKGROUND

An operating system refers to the program code that manages the computer hardware and program code resources. That is, the operating system of a computer is what allows the various hardware components to interoperate with one another to perform an intended function. Different computers and their hardware resources, program code resources, and peripheral devices may implement different operating systems that may be incompatible with one another.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a computing device bridge to provide a direct point-to-point connection between computing devices, according to an example of the principles described herein.

FIG. 2 is a diagram of a computing device bridge to provide a direct point-to-point connection between computing devices, according to an example of the principles described herein.

FIG. 3 is a flowchart of a method for facilitating resource sharing between multiple computing devices, according to an example of the principles described herein.

FIG. 4 is a diagram of a computing device bridge to accommodate computing devices with different operating systems, according to an example of the principles described herein.

FIG. 5 is a flowchart of a method for facilitating resource sharing between multiple computing devices, according to an example of the principles described herein.

FIGS. 6A-6E depict various display device sharing scenarios, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations that coincide with the description; however, the description is not limited to the examples and/or implementations provided in the drawings.

### DETAILED DESCRIPTION

Computing devices have various hardware resources and program code resources to execute different functionalities. The operating system (OS) of the computing device refers to program code used to manage the hardware and program code resources of the computing device. Different computing devices may have different OSes. Examples of operating systems include Windows®, Mac OS®, and Linux®. These operating systems may be incompatible with one another. For example, an application that is intended to be executed on a Windows-based computing device may not be able to function on a Mac OS-based computing device.

Users may rely on different computing devices, some with incompatible OSes, to perform an intended function. For example, a fashion designer may have expertise working with Mac OS-based computing devices. However, the fashion designer may use tools and data capture devices that are intended for a Windows-based computing device. As such, the fashion designer may desire to transfer material image captures from the Windows-based data capture device to the Mac-based computing device. The transfer of information from one OS platform to another OS platform may be complex and difficult, if even possible. For example, the user may have to login to a Windows-based computing device to capture the data and then load the data, which may be large, to a network-attached server. The user would then login to a Mac-based computing device and transfer the data from the network-attached server to the Mac-based computing device, assuming the Windows-based data is compatible with the Mac-based computing device. Clearly the back and both between these two OS environments make this workflow slow and cumbersome.

As another example, a data scientist may rely on Linux-based tools given certain characteristics that are favorable when collecting large data sets. For example, a Linux-based computing device may process data faster than a Windows-based computing device. The faster speeds of the Linux-based computing device may be particularly relevant for a data scientist who regularly encounters large data sets. However, certain Windows-based applications, such as Excel® or Tableau® may be more efficient at analyzing the large data sets and presenting the data. As with the fashion designer, a data scientist may become encumbered by the tedious, time-consuming, and perhaps complex operation of switching between computing environments to carry out the tasks. While particular examples are presented of users interacting with computing devices with different OS platforms, similar inconveniences may be experienced by users who interact with and transition between computing devices with the same OS platform.

Accordingly, the present specification describes a computing device bridge that seamlessly integrates both computing environments with a low-latency direct connection. Specifically, the computing device bridge of the present specification is a highly responsive, low-latency, multi-computer, multi-OS, resource, and system sharing device. The computing device bridge of the present specification enables users that execute workflows with computing devices that have the same or disparate OSes to fuse those environments into a single productivity environment. That is, two, three, or more computing devices that have the same or different OS platforms maybe be fused/integrated with this computing device bridge. Sharing and switching of resources such as storage devices, data, display devices, input devices (keyboard, mouse, digital pen, printers, etc.) are availed by the computing device bridge and make multi-computer-environment workflows seamless by their extension. While specific reference is made to particular OS platforms, the present specification may integrate workflows from any variety of disparate OS platforms to a single computing environment.

Two specific examples are presented. In a first example, a user may have a Windows-based computing device that is used while the user is away from his/her desk. The user may want the capability to resource share with his/her desktop computing device when back at his/her desk/office. In another example, an employee may have a Windows-based computing device at work and may want to resource share with his/her personal (home based) Mac-based or Windows-based computing device when working from home or at remote worksites. The cross-OS resource sharing computing device bridge of the present specification may be implemented in these, and other, scenarios.

Specifically, the present specification describes a computing device bridge. The computing device bridge includes a first communication port to establish a connection with a first computing device, having a first OS, and a second communication port to establish a connection with a second computing device that has a second OS. The computing device bridge also has a controller to 1) provide a direct point-to-point connection between the first computing device and the second computing device and 2) share a resource of the first computing device or the second computing device with the other of the first computing device and the second computing device.

The present specification also describes a method. According to the method, a computing device bridge establishes 1) a connection with a first computing device having a first operating system (OS) and 2) a connection with a second computing device having a second OS, which OS may be of the same platform or a different platform than the first OS. A direct point-to-point connection is provided between the first computing device and the second computing device notwithstanding the different OS platforms. The computing device bridge facilitates the sharing of resources between the first computing device and the second computing device. An input device of one of the first or second computing device is detected as a controlling input device. The controlling input device is capable of controlling both the computing devices. As such, the computing device bridge facilitates user interaction with both computing devices via the controlling input device. This may be done by converting resource metadata of the computing devices to be compatible with one another. To simplify the description, particular reference is made to a first and second computing device. However, additional computing devices may be added as well and the method and computing device bridge may operate as described in the present specification.

In another example, the computing device bridge includes a first communication port to establish a connection with a first computing device having a first OS and a second communication port to establish a connection with a second computing device having a second OS, wherein the second OS has a different platform than the first OS. The computing device bridge includes a multiplexer to multiplex display and data signals from the first communication port and the second communication port. A reflector of the computing device bridge identifies hardware components coupled to the first computing device and the second computing device. In this example, the controller of the computing device bridge 1) provides a direct point-to-point connection between the first computing device and the second computing device, 2) shares resources of one of the first computing device and the second computing device with the other of the first computing device and the second computing device, and 3) converts resource control data from one of the first and second computing device to be compatible with the other of the first and second computing device.

As will be described below, using computing device bridges and methods as described herein may, for example, 1) provide one seamless computing environment that integrates multiple computing environments that have the same or different OS platforms and different program code functionalities; 2) share displays in different modalities; 3) automatically install multi-OS program instructions upon connection to the computing device bridge; 4) provide power for recharging and operating attached peripheral devices and computers; and 5) seamlessly integrates home and work computing environments, peripherals, and IO modalities for ergonomic and efficient workflows. However, it is contemplated that the devices disclosed herein may address other matters and deficiencies in a number of technical areas, for example.

As used in the present specification and in the appended claims, the term, “controller” includes a processor and memory. The processor includes the circuitry to retrieve executable code from the memory and execute the executable code. As specific examples, the controller as described herein may include machine-readable storage medium, machine-readable storage medium and a processor, an application-specific integrated circuit (ASIC), a semiconductor-based microprocessor, a central processing unit (CPU), and a field-programmable gate array (FPGA), and/or other hardware device.

The memory may include a machine-readable storage medium, which machine-readable storage medium may contain, or store machine-usable program code for use by or in connection with an instruction execution system, apparatus, or device. The memory may take many forms including volatile and non-volatile memory. For example, the memory may include Random-Access Memory (RAM), Read-Only Memory (ROM), optical memory disks, and magnetic disks, among others. The executable code may, when executed by the respective component, cause the component to implement the functionality described herein.

As used in the present specification and in the appended claims, the term “a number of” or similar language is meant to be understood broadly as any positive number including 1 to infinity.

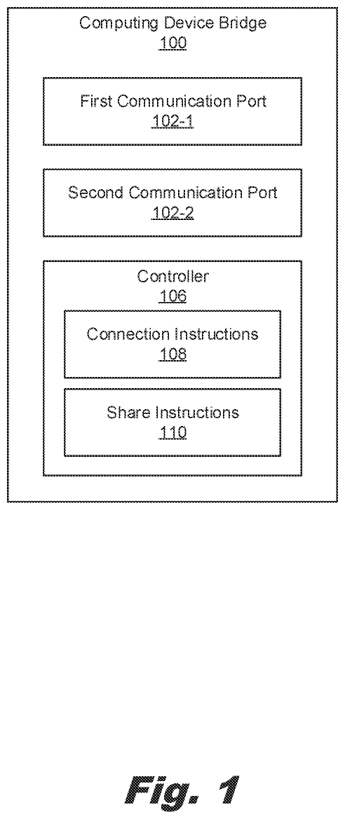

Turning now to the figures, FIG. 1 is a block diagram of a computing device bridge (100) to provide a direct point-to-point connection between computing devices, according to an example of the principles described herein. As described above, the computing device bridge (100) provides the capability of a direct point-to-point connection between computing devices with the same OS platform or with disparate OS platforms, such that a user may seamlessly operate across the computing devices notwithstanding any incompatibility between the computing devices and/or OSes. For example, a user may have both a stationary desktop/workstation and mobile computing device and may want to link the two computing devices together to create a more powerful work environment. As a specific example, the user may want to utilize the mobile computing device while away from his/her desk. When done with the mobile work session, the user may want to recharge the mobile computing device until the next work session and/or continue his/her work session using the more powerful desktop computing device. In the latter case, the computing device bridge (100) provides a connection between the desktop computing device and the mobile computing device so that files can be shared even when the mobile computing device and desktop computing device have disparate and potentially incompatible OS platforms.

As another example, an employee may have a mobile computing device that is transportable, such that the employee may take the mobile computing device to meetings. Following a meeting, the user may return back to his/her desk and plug the mobile computing device into the computing device bridge (100) to be recharged and to allow the sharing of any files that were created or modified during the meeting to the more powerful, stationary desktop computing device. At the desk, the employee may utilize the desktop computing device as it has more computing power and may have more peripherals used to enhance the working environment. The connection between the mobile computing device and the stationary computing device would further enhance the work environment by adding the extra display plus any unique, sharable devices from the mobile device to the work environment.

Accordingly, the computing device bridge (100) may include a first communication port (102) to establish a connection with a first computing device. The computing device bridge (100) may also include a second communication port (102-2) to establish a connection with a second computing device. That is, the computing device bridge (100) may facilitate connection of multiple computing devices such that a user may operate both at the same time, or seamlessly switch between operation of the two computing devices. Moreover, as will be described below, resources which may be found on one computing device, or natively attached to one computing device, may be shared with the other computing device, without having to transfer data to a remote intermediary such as a network-connected server. While particular reference is made to two communication ports (102), the computing device bridge (100) may include any number of additional communication ports.

Moreover, as described below, the communication ports (102) may be remote ports where the associated computing devices are not physically connected to the computing device bridge (100), but are at a different physical location from the computing device bridge (100). As yet another example, the ports (102) themselves may be remote, for example as a PC over IP (PCoIP) connection where the controller (106) creates a remote channel/tunnel to the remote communication port and routes the same data as would be routed were the connection local. In this example, the remote communication port may have a network connection with the computing device bridge (100).

In some examples, the first computing device and the second computing device may have the same OS platform. However, in other examples, the first computing device may have a first OS platform while the second computing device may have a second OS platform that is different than, and in some cases incompatible with, the first OS platform. For example, a Windows-based computing device may be intended to execute Windows-based applications, which Windows-based applications may be incompatible with a Mac OS-based computer. Accordingly, the present computing device bridge (100) allows the files and resources which are otherwise intended for a Windows-based computing device, to be implemented on a computing device with another OS platform, such as Mac OS. As will be described below, the resources that are shared between the computing devices are multiple and varied.

The ports (102) may be of a variety of types as well. In one particular example, the ports (102) may be universal serial bus (USB) ports, specifically USB type-C ports to receive USB type-C connectors. USB type-C ports facilitate high data transfer rates between the computing devices. In one example, the ports (102) may be Ethernet ports such that the computing devices may be remote from one another. While particular reference is made to particular ports, the ports (102) may be of different types as well including for example, a Thunderbolt™ port, and a fiber optic port. Moreover, while particular reference is made to wired ports, the ports (102) may be wireless communication ports such as WiFi 6 ports or Ultra-Wide-Band (UWB) ports to establish a direct wireless communication path between the computing devices. Note that the first communication port (102-1) and the second communication port (102-2) may be of different types. For example, the computing device bridge (100) may include a first communication port (102-1) that is wireless and a second communication port (102-2) that is USB type-C. As such, the computing device bridge (100) provides a hybrid connection system where computing devices may be connected by both wired USB and wireless communication data streams.

In an example, the first communication port (102-1), the second communication port (102-2), or a combination thereof provide power to an associated first or second computing device. For example, the USB ports may be USB type-C ports with power delivery (PD) functionality wherein the first or second computing device may be re-charged through a power supply of the computing device bridge (100) or the other computing device.

The computing device bridge (100) also includes a controller (106). In general, the controller (106) provides a direct point-to-point connection between the first computing device and the second computing device and shares some or all of the functionality of resources of the first computing device and the second computing device with the other of the first computing device and the second computing device. Accordingly, the controller (106) may execute connection instructions (108) to establish the point-to-point connection and share instruction (110) to share the resources. In some examples, the direct point-to-point connection between the computing devices is a dedicated point-to-point connection where no other devices are in communication with the computing device bridge (100) or the associated computing devices.

In some examples, to enable resource-sharing, the controller (106) may convert resource metadata and/or control data. That is, the controller (106) may translate the file formats or data streams for I/O devices between different OS platforms. Specifically, the computing device bridge (100) identifies the different OS platforms that are attached and converts/translates the shared resources data streams so that each respective OS treats the resources as being native in their environment. The files and data that are converted may include the files operated on and/or the control data that controls the peripheral devices.

The sharing technique may vary from device to device. At the lowest, level, the controller (106) may switch the USB traffic between computing devices. In another example, the controller may acquire the data to be shared at a higher level or trigger a switch between computing devices when data transfer is idle.

In a particular example of resource sharing, the first computing device may include certain applications and may be coupled to certain peripheral devices. In this example, a user using the first computing device may push data to the second computing device. A user using the second computing device may have access to retrieve data from the first computing device and/or interface with the peripheral devices of the first computing device to execute an intended function. For example, via human interface devices (HIDs) of the second computing device, a user may access the first computing device to execute an application associated with a scanner coupled to the first computing device or to retrieve a data file stored on memory resources of the first computing device. In this example, the user input from the second computing device HIDs may control the first computing device. As described in more detail below, the controller (106) includes hardware components and program code that facilitate and accommodate any incompatibilities between the disparate OSes, for example by converting control signals and/or data files to be compatible with one another.

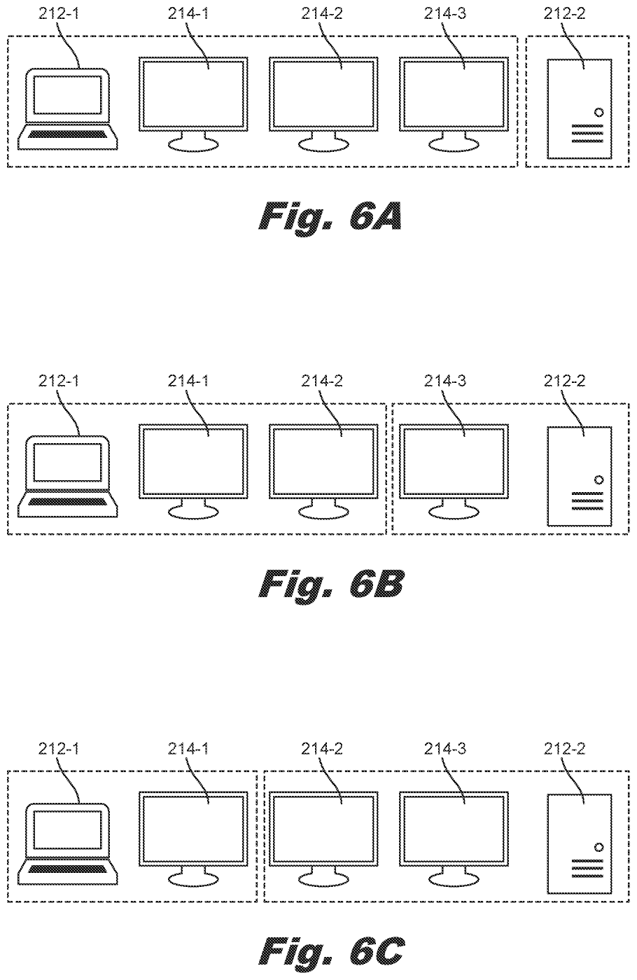

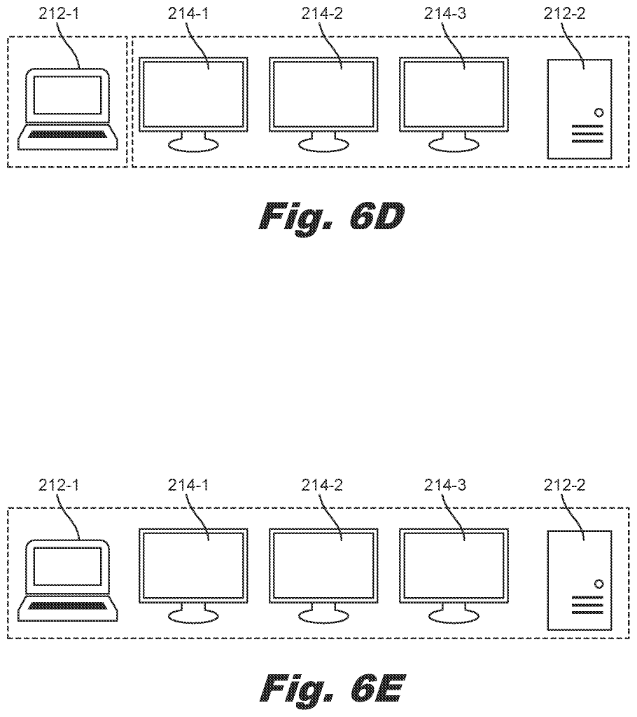

As such, there are a variety of resources that may be shared between the computing devices. Examples include memory resources, processing resources, a graphics processing resource, display devices, a user input device, a peripheral device, program instructions, an application, or combinations thereof. Additional specific examples include a mouse, keyboard, camera, printer, or other human interface device (HID). The resource may also be data that is shared between the computing devices. Moreover, the first computing device may view information, and control what information is displayed, on display devices coupled to both the first computing device and the second computing device. An example of different display device sharing environments is presented below in connection with FIGS. 6A-6E.

As yet another example, peripheral devices such as input and output devices may be shared. For example, a Mac OS-based computing device may access a printer coupled to a Windows-based computing device to print documents that originate from either the Windows-based computing device or the Mac OS-based computing device. Again, as described above, the computing device bridge (100) may facilitate any conversion of files and/or control signals such that the second computing device may control and access the input and output devices.

In yet another example, the first computing device may access applications on the second computing device. For example, via a mouse of the first computing device, the user may move a cursor to the second computing device screen and click on an icon to open an application on the second computing device, and with that mouse input may execute the application.

In some examples, the controller (106) is to share the resources of the first computing device and the second computing device based on a historical sharing configuration previously used when the first and second computing devices were coupled to the computing device bridge (100). That is, during sharing, certain sharing parameters, such as access rights, sharing preferences, etc. may be established. Accordingly in this example, upon identification of computing devices that have simultaneously coupled to the computing device bridge (100), the controller (106) may implement the previously used access rights and sharing preferences.

As a particular example, when using a particular application on one OS platform, an artificial intelligence (AI) controller (106) may learn the configuration of resources the users implement and may suggest or implement that configuration when the computing devices are later coupled together. Similarly, when certain files are opened, the user may historically save data to multiple locations and the AI controller (106) may discover this pattern and may suggest additional locations to save the file. As yet another example, the AI controller (106) may suggest use of a remote compute resource for the user if the operation on a local computer is too operationally intensive for that platform. A remote communication port (102) may facilitate such remote compute resource utilization.

Accordingly, the present computing device bridge (100) accommodates sharing of resources across computing devices which in some examples are otherwise incompatible with one another. This may be done by recognizing user input on a first computing device from an HID coupled to a second computing device and transferring the recorded user input to control the first computing device.

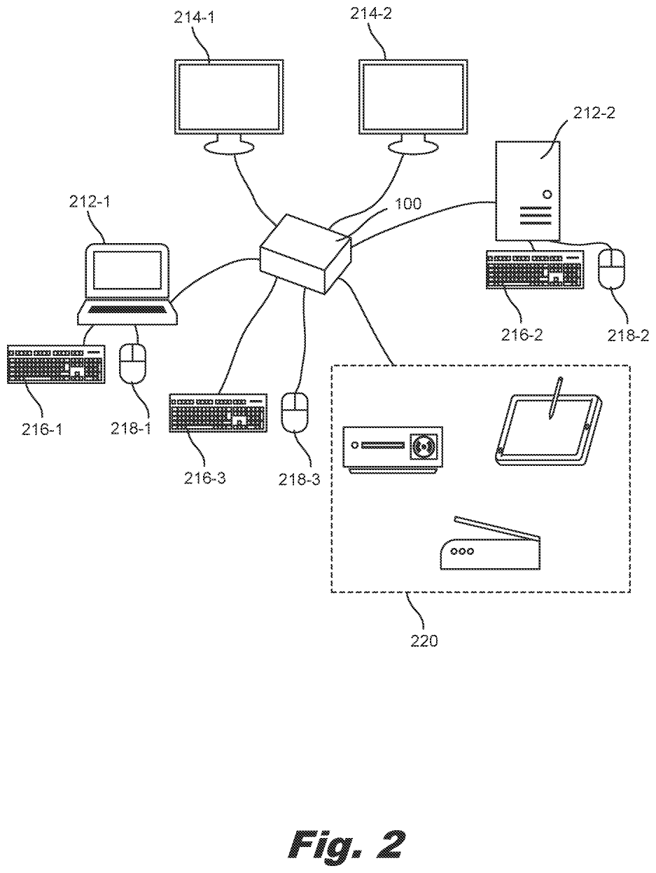

FIG. 2 is a diagram of a computing device bridge (100) to provide a direct point-to-point connection between computing devices (212-1, 212-2), according to an example of the principles described herein. As described above, the computing device bridge (100) facilitates the sharing of resources, such as hardware resources, applications, data files, etc. between the computing devices (212), notwithstanding the computing devices (212) having different, and potentially incompatible, OS platforms. For example, an HID that is integrated with or natively coupled to a first computing device (212-1), which is a laptop, may be used to access the data resources and applications on the second computing device (212-2) which may be a desktop tower. That is, a keyboard (216-1, 216-2, 216-3), mouse (218-1, 218-2, 218-3), or other HID attached to either computing device (212-1, 212-2) or the computing device bridge (100) itself, may be used to interact/input with any attached computing device (212) regardless of the platform of the computing device (212) OS. Similarly, any peripheral device that is connected to either computing device (212), or the computing device bridge (100) itself, may be shared between computing devices (212) such that either computing device (212) sees the peripheral device as being natively attached. Accordingly, the computing device bridge (100) coordinates and manages peripheral sharing between the multi-OS computing devices (212-1, 212-2).

Accordingly, the computing device bridge (100) may include a number of peripheral device ports such that the peripheral devices, such as a keyboard (216-3), mouse (218-3), first display device (214-1), second display device (214-2), or any other variety of peripheral devices (220) may be coupled directly to the computing device bridge (100). As described above, these peripheral devices may provide a user access to either computing device (212) regardless of the OS of the computing device (212). Accordingly, peripherals may be shared between the computing devices (212).

As a particular example, the display devices (214-1, 214-2) may be split between the computing devices (212) or used by just one of the computing devices (212) as depicted in FIGS. 6A-6E. It should be noted that some display controllers manage display devices (214) differently and the computing device bridge (100) may account for such. For example, a computing device (212) display driver may communicate with a graphics processing unit (GPU) which converts text and graphical information into pixels. When grabbing a frame buffer of pixels from the second computing device (212-2) to be displayed on a display device connected to the first computing device (212-1), the computing device bridge (100) may compress and decompress the incoming and outgoing video stream data. Specifically, the pixel data from the second computing device (212-2) may be compressed as it is transmitted to the first computing device (212-1). Accordingly, the computing device bridge (100) displays content with the appropriate compression and decompression codex's such that distribution to a target display device aligns with the modality put in place by the user.

In an example, the computing device bridge (100) allows for moving files and directories between attached computing devices (212) with disparate OSes via drag-and-drop functionality. Differing file formats for different OS computing devices (212) is accounted for by the controller (106) program code. In some examples, the computing device bridge (100) may automatically synchronize file versions/updates between a single or multiple directories of files. The directories may be setup and managed from any connected computing device (212) via an agent installed on each computing device (212). As a particular example, a word processing file, or an image capture file stored in the first computing device (212-1) may be selected via a mouse (218) and dragged and dropped onto a display device (214) associated with the second computing device (212-2), which second computing device (212-2) may operate based on a disparate OS platform. Accordingly, the present specification describes a computing device bridge (100) that allows moving files between different OS platforms by converting the files from a format compatible with the first computing device (212-1) to a format that is compatible with the second computing device (212-2). That is, the computing device bridge (100) transfers and synchronizes files between attached computing devices (212) and converts the format of the files when appropriate.

Accordingly, the controller (106) executes instructions to manage the HID (e.g., mouse (218), keyboard (216), and other HID) inputs and sends the transition between display devices (214-1, 214-2) and/or other display associated systems to be reflected to the appropriate other attached computing devices (212). That is, the computing device bridge (100) may natively share all peripherals (USB, Wi-Fi, etc.) with standard OS-based drivers (e.g., HID drivers for Windows) as well as selected custom drivers (e.g., Wacom devices) via accommodation through the attached controller (106) program code. As such, a user may print from an attached printer to the Windows-based computing device (212) from an attached Mac OS-based computing device (212) and vice versa.

In an example, input directly to the peripheral ports on the computing device bridge (100) may be directed to the mouse-selected attached computing device (212). That is, a mouse (218-3) may move across display devices (214) and the location of the mouse (218-3) on a display device associated with one of the computing devices (212) may select that particular computing device as the engaged device such that keyboard input is processed and displayed on the particular computing device.

Based on this detection, the output of an HID coupled directly to the computing device bridge (100) is displayed on a display device (214) associated with the active input device and utilizes memory and processing resources of the computing device (212) to which the active input device is coupled.

While particular reference is made to particular functionalities of the computing device bridge (100), a variety of other functionalities may be performed by the computing device bridge (100). For example, the computing device bridge controller (106) may enforce security protocols. For example, the computing devices (212) may be authenticated prior to resource sharing with other computing devices (212) coupled to the computing device bridge (100). This may be implemented via identifiers of the computing devices (212) and/or a username and password to login to a resource-sharing agent on the computing devices (212). As another example of a security functionality, the computing device bridge (100) may enforce certain sharing restrictions. For example, a user or administrator may define which resources, (e.g., data files) may be shared and transported to other computing devices (212). Accordingly, the present computing device enables a seamless integration of resources of disparate computing devices (212) into a single environment where a user may interface/interact with each resource regardless of the disparate OSes of the computing devices (212).

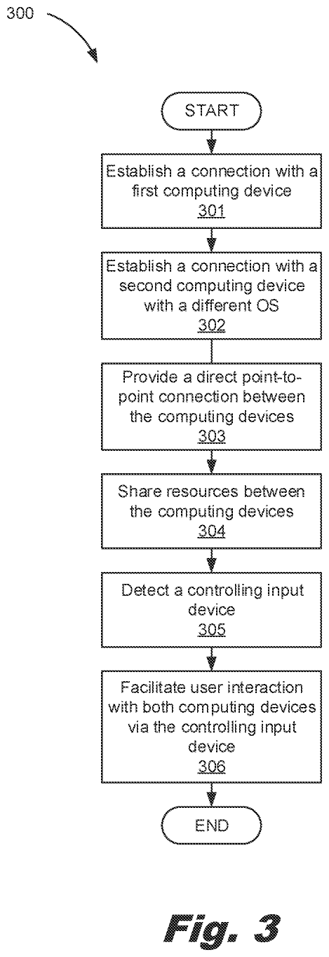

FIG. 3 is a flowchart of a method (300) for facilitating resource sharing between multiple computing devices (212), according to an example of the principles described herein. According to the method (300), a connection is established (block 301) with a first computing device (212-1). Similarly, a connection is established (block 302) with a second computing device (212-2). As described above, the connections may be of any wired or wireless type including USB type-C, Ethernet, Wi-Fi or UWB. As described above, before or during the establishment (block 301, 302) of the connections, the computing device bridge (100) may authenticate or authorize the computing devices (212), which may include authentication/authorization of the users and/or computing devices via identifiers, username/password, or other authorization protocol.

With both connections established, the computing device bridge (100) provides (block 303) a direct point-to-point connection between the first computing device (212-1) and the second computing device (212-2). That is, rather than uploading data to an intermediary, such as a network-connected server, the present computing device bridge (100) provides direct communication, data sharing, and resource sharing between the computing devices (212).

Accordingly, the computing device bridge (100) may share (block 304) resources between the computing devices (212). For example, hardware components that are natively coupled to one of the computing devices (212) may control, or be controlled by, the other computing device (212). As a particular example, a keyboard of a first computing device (212-1) may be used to enter data into a spreadsheet executing on a second computing device (212-2). In another example, the first computing device (212-1) may access a printer coupled to the second computing device (212-2) to print a document that is generated on either the first computing device (212-1) or the second computing device (212-2). In yet another example, the sharing of resources may be data or other files stored on one computing device (212). For example, a document or file stored on the first computing device (212-1) may be dragged-and-dropped onto the second computing device (212-2) where it may be opened and/or worked on.

To facilitate such user interaction with both computing devices (212), the computing device bridge (100) may detect (block 305) a controlling input device of one of the first and second computing device (212) to control both the computing devices (212). That is, a user may control and have access to both computing devices (212) via a single input device which is moved between display devices (214) associated with either computing device (212). It is via these input devices that resources are shared. For example, via a keyboard or mouse, user input may be received. Accordingly, identifying which of the input devices is to be a controlling input device dictates which user input is received. In some examples, such detection is based on user activation of that input device.

The user may select any keyboard or mouse attached to the hybrid compute environment and that mouse, and wherever that mouse is pointed, may be the engaged computing device (212). The mouse fluidly transitions between display devices (214) associated with any of the attached computing devices (212) and transfers keyboard input to that mouse-engaged computing device (212) as well. This functionality is provided by the controller (106) which is able to, in real-time, be a reflector of peripheral inputs connected to the multiple computing devices (212). That is, the controller as a reflector enables communication between multiple computing devices where data from one computing device is routed across the devices between the computing devices. As described above, the reflector is integrated with the controller (106). The reflector functionality may be provided when the communication ports (102) are USB ports. That is, USB devices may have “Host” or “Device” mode functionality. Computing devices (212) in Host mode may communicate with attached downstream Devices. A Host may not have the ability to communication with other Hosts. Via the reflector however, Host devices may communicate with one another.

In this manner, keyboard and mouse inputs are provided to the computing device (212) the user wants to use with almost no latency. With the simple motion of the mouse, the user can be immediately redirected to another attached computing device (212) to continue their workflow in that compute environment. That is, a user may pick up and use any computing device-attached mouse or attach one directly to the computing device bridge (100) as depicted in FIG. 2. Agents on each computing device (212) communicate in real-time as to the location of the mouse and to what computing device-associated display the mouse is directed at. That computing device (212) is the computing device (212) that is to be the engaged device. Any keyboard activity is then directed at that computing device (212) and any application that is running on that computing device (212).

For example, the agent on each computing device (212) tracks the location of the in-use pointing device (e.g., mouse). For example, a first computing device mouse (218-1) may cross over the boundary of the edge of its assigned display and hence transition into the display and functional space of the second computing device (212-2). The agent on the first computing device (212-1) then starts sending received pointing device location or relative motion coordinates to the second computing device (212-2) agent. The second computing device (212-2) agent then uses this stream of position data to control the location of the cursor of the second computing device (212-2) rather than having the second computing device (212-2) native or attached pointing device control the location of the cursor.

As such, these agents in both computing devices (212) communicate back and forth on a continuous (real-time) basis via the direct point-to-point communication link set up between them to 1) coordinate control of cross-linked control functionalities to include pointing device interoperability, 2) display data sharing and redirection, 3) transfer files, both manual and as directed by coordinate pointing devices, and 4) automatic setup for file syncing and other computing system automatic transfers, and 5) directing of one computing device (212) output to the other computing device (212) peripherals and vice versa.

As described above, it may be the case that different computing devices (212) OSes are incompatible, such that resources are controlled using a different programming language and that the metadata and data associated with shared resources differs from one another. In this example, the computing device bridge (100) facilitates (block 306) user interaction with both computing devices (212) via the controlling input device by converting resource metadata of the computing devices to be compatible with one another. That is, as described above, control signals that translate the user input at a user input device may be converted from one format into another format.

FIG. 4 is a diagram of a computing device bridge (100) to accommodate computing devices (212) with different operating systems, according to an example of the principles described herein. As described above, the computing device bridge (100) may have a variety of ports (102) connecting various computing devices (212-1, 212-2, 212-3) to the computing device bridge (100) and to each other. Also as described above, these ports (102) may be of a variety of types including a USB type C/USB 3 port. While FIG. 4 depicts three computing devices (212), any number of computing devices (212) may be integrated into a single environment via the computing device bridge (100). As described above, each computing device (212) may include natively-coupled peripheral devices such as a display device, keyboard, mouse, and other peripheral devices (220-1, 220-2, 220-3). As described above, the natively-coupled peripheral devices of any of the computing devices (212) may be accessible to other computing devices (212) via the computing device bridge (100).

Moreover, as described above, these computing devices (212) may interoperate with one another regardless of any incompatibility of their native OSes. That is, the computing device bridge (100) includes circuitry to convert resources and control signals for various resources into formats compatible with a target computing device (212).

In addition to the communication ports (102), the computing device bridge (100) may include a number of peripheral device ports to establish a connection with a peripheral devices. For example, computing device bridge (100) may include USB 3.0 ports to connect directly to peripheral devices such as a keyboard, a mouse, or another peripheral device (220-4). The computing device bridge (100) may also include additional peripheral device ports specifically for establishing a connection with additional display devices (214-1, 214-2). These ports may be any variety of video-type ports including DisplayPort and a high-definition multimedia interface (HDMI) ports, among others.

As described above, the controller (106) may share the peripheral devices coupled to the bridge peripheral ports with the first computing device (212-1) and the second computing device (212-2) as well as any other connecting computing device (212). That is, the present computing device bridge (100) provides great flexibility as input devices natively connected to either computing device (212) or input devices natively connected to the computing device bridge (100) may be used to control any of the computing devices (212) and access their corresponding peripheral devices. That is, the user may select any keyboard or mouse attached to the hybrid compute environment and that mouse, and wherever that mouse is pointed, will be the engaged or active computing device (212) that the user is communicating with and targeting action on and the one to which keyboard input is directed. That is, as described above, the mouse may be used to direct, via the display it is directed at, which of the computing devices (212) keyboard input should be passed to.

FIG. 4 also depicts various components of the controller (106). Specifically, FIG. 4 depicts the controller (106) which as described above provides a direct point-to-point connection between the computing devices (212), shares resources of the computing devices (212) with other of the computing devices (212), and converts resource control data from one of the first and second computing device to be compatible with the other of the first and second computing device.

To carry out that intended functionality, the controller (106) may include various components. Specifically, the controller (106) includes a multiplexer (426) to multiplex display and data signals into and out of the different computing devices (212). The multiplexer (426) may be implemented as hardware, program code, or combinations thereof. A router (424) formed on a hub (422) directs the signals to and/from the controller (106) which in some examples performs any resource metadata and file conversions described above. In another example, the resource metadata and file conversions happen in the attached compute device agents (434). In this last example, the computing device bridge (100) routes data between the attached computing devices (212).

The user input and specific connect and share instructions may dictate how the multiplexer (426) and router (424) are set-up to ensure that the file data or peripheral data flows between each of the computing devices (212). That is, the configurations of the router (424) and the multiplexer (426) are variable, and change based on the intended source and destination of the data, which is dictated by the user input. In an example, there may be multiple redundant instances of each router or multiplexer to handle concurrent actions.

In general, the hub (422) enables communication between the computing devices (212) and the peripheral devices connected to them. The controller (106) also includes a video router (432) that similar to the router (424) directs signals to and from the display devices (214) to the controller (106) and computing devices (212).

In some examples, each computing device (212) has an agent (434) installed thereon that facilitates the resource sharing through the computing device bridge (100). In general, the agent (434) presents itself on a computing device (212) where a mouse is directed and which is the main operational system/platform at that point. The agent (434) allows for selection of display configuration (primary, mirrored, extended, split-screen or rotated), selected input source(s), allowed shared devices for computing device(s), synced folder(s), additional storage locations dependent of file or application use, security settings, and other shared functionalities.

As a specific example, the agent (434) is responsible for representing any display devices (214) attached to other computing devices (212), but used by the computing device (212) that is engaged. For example, the agent (434) may be responsible for taking a pixel stream form a different computing device (212) and displaying the pixel stream on the computing device (212) on which the agent (434) is running.

In an example, this agent (434) may allow for selection, setup, and configuration of the fused/hybrid compute environment to the user's preference for execution of any particular workflow. The agent (434) may provide a variety of functions. For example, the agent (434) may enforce certain security measures. As described above, the computing device bridge (100) may authorize computing devices (212) to participate in resource sharing. The agent (434) may facilitate this authorization by collecting and transmitting authentication data to the computing device bridge (100) and granting the computing devices (212) with access to the computing device bridge (100) following authentication. As another example, the agent (434) may synchronize the resources. For example, where the different computing devices (212) include similar files, the first agent (434-1) corresponding with other agents (434-2, 434-3) may ensure that the version on the associated computing device (212-1) is the most up to date and matches other versions on other computing devices (212-2, 212-3). Such synchronization may be automatic, for example upon connection to the computing device bridge (100) or may be manually triggered via user input.

Via the agent (434), a user of the computing device bridge (100) may implement certain resource sharing configurations and/or manage the resource sharing environment. For example, the user may designate resources that are restricted from sharing and may also indicate which other computing devices (212) are authorized to view and access shared content. While particular reference is made to particular agent functionalities, other functionalities may be provided by the agent (434).

Prior to engaging in the resource-sharing environment, the agent (434) is to be installed on each computing device (212). In one example, the computing device bridge (100) includes a memory device (430) to store the agent program code that is to be installed on the computing devices (212). This memory device (430) may be of a variety of types including solid state memory and flash memory, among others. In this example, the controller (106) may, upon connection of the computing devices (212), transmit the agent (434) program code from the memory (430) through the IO bridge (428) and out to the computing devices (212) to be installed. That is, the computing device bridge (100) facilitates the automatic download of the agent (434) onto any new and authenticated computing device (212) attached to the computing device bridge (100).

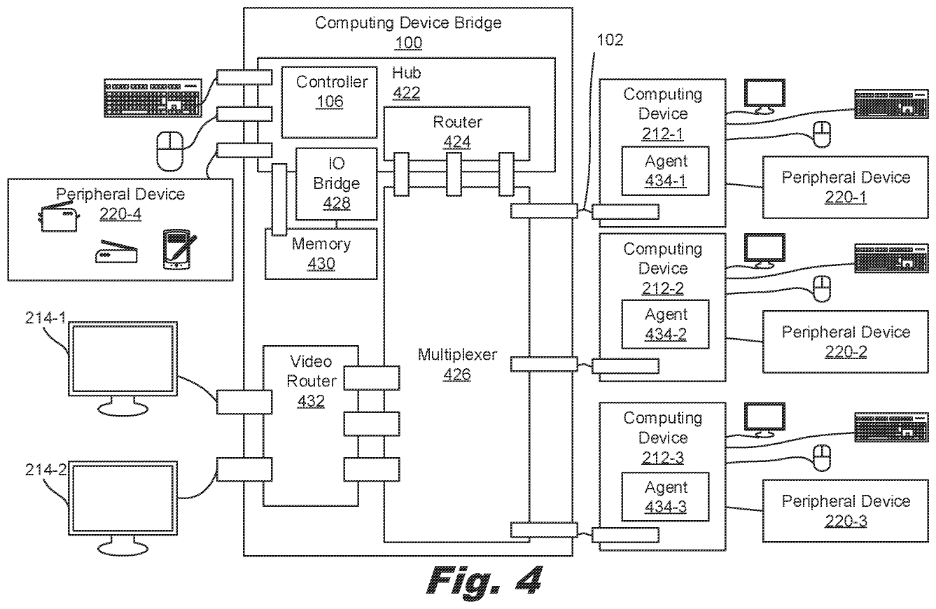

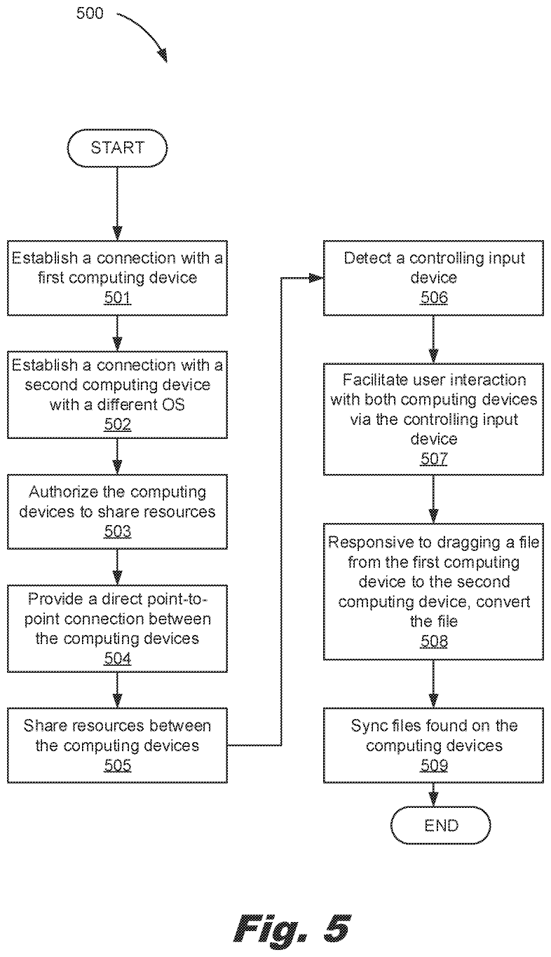

FIG. 5 is a flowchart of a method (500) for facilitating resource sharing between multiple computing devices, according to an example of the principles described herein. According to the method (500), connections are established (block 501, 502) with both a first computing device (212-1) and a second computing device (212) coupled to a computing device bridge (100). These operations may be performed as described above in connection with FIG. 3.

As described above, in some examples, the first computing device (212-1) and the second computing device (212-2) may be authorized (block 503) to share resources with one another. That is, it may be desirable to enforce certain access restrictions such that a malicious user does not gain uncontrolled access to any one of the computing devices (212). Accordingly, the controller (106) may include a register or database that identifies computing devices (212) which are authorized to resource share. In another example, the controller (106) may communicate with a remote database to authorize the computing devices (212) to share resources.

In either case, upon connection of a computing device (212) to the computing device bridge (100), the computing device bridge (100) may receive an identifier of the computing device (212) or may otherwise identify the computing device (212). Responsive to the identification and authorization of the computing device(s) (212), the computing devices (212) may be provided access to the controller (106) which facilitates resource sharing. Previous to such identification and authorization, each computing device (212) may be operated independently, with access to each computing device's (212) resources restricted to just that computing device (212).

Once authorized, the computing device bridge (100) may provide (block 504) the direct point-to-point connection between the computing devices (212) and share (block 505) resources between the computing devices (212). These operations may be performed as described above in connection with FIG. 3. A controlling input device is detected (block 506) which facilitates (block 507) user interaction with both computing devices (212). These operations may also be performed as described above in connection with FIG. 3. That is, the controlling input device controls the focus of the other peripherals, perhaps based on a policy, such that some peripherals follow the focus of the controlling input device while others do not. For example, a user may want a tablet to switch between computing devices (212). However, if the user is printing from the first computing device (212-1) and switches focus to the second computing device (212-2), the user may not want the printer to switch from being under the control of the first computing device (212-1) to being under the control of the second computing device (212-2). Accordingly, in this example, the ability and protocols for switching each peripheral device may be governed by a policy specific to that peripheral device regarding when to switch between computing devices (212).

Part of the user interaction may include the dragging and dropping of a file from a first computing device (212-1) to a second computing device (212-2) or vice versa. However, as described above, as the files may be generated or intended to be used in conjunction with a particular OS, such files may not be compatible with the second computing device (212-2) which may operate based on a second OS. Accordingly, responsive to the user dragging and dropping a file from the first computing device (212-1) to the second computing device (212-2), the file may be converted (block 508) into a format compatible with the second computing device (212-2). That is, the file may be converted from a format compatible with an OS of the first computing device (212-1) into a format compatible with the second computing device (212-2). This may include converting file metadata to ensure proper execution and use of the file on the second computing device (212-2). In some examples, the conversion is performed by a processor of the first computing device (212-1), before the file is copied to the new location on the second computing device (212-2). In another example, the conversion is performed by a processor of the second computing device (212-2). In yet another example, the conversion may be performed by the controller (106) of the computing device bridge (100).

In an example, the method (500) includes syncing (block 509) files found on the first computing device (212-1) and the second computing device (212-2). That is, as described above, it may be that a user copies a file or dataset to a portable laptop computing device during remote work. Accordingly, upon connection to the computing device bridge (100) and following alteration of the file on the laptop computing device, the file is now different than the original file due to the user's remote work. Rather than relying on the user manually re-copying the revised file or dataset to the first computing device (212-1), the method (500) may include synchronizing (block 509) the files such that any alterations made by the user to the file or dataset on the second computing device (212-2) is automatically updated to the file or dataset as stored on the first computing device (212-1). Such synchronization may be based on metadata, such as a version number or timestamp associated with a latest access/save of the file or dataset. In other words, the method (500) ensures that each of the first computing device (212-1) and the second computing device (212-2) have stored thereon the most up-to-date instance of a file or dataset and may do so responsive to connection of computing devices (212) to the computing device bridge (100).

FIGS. 6A-6E depict various display device (214) sharing scenarios, according to an example of the principles described herein. As described above, there may be multiple computing devices (212-1, 212-2) and multiple display devices (214-1, 214-2, 214-3) coupled to the computing device bridge (100) and any combination of these display devices (214) may be under control of different computing devices (212) as depicted in FIGS. 6A-6E. The dashed boxes in FIGS. 6A-6E depict groupings of display devices (214) with the respective controlling computing device (212). All display modes supported by the OS or graphics card in the managing computing device (212) are supported (e.g., extended or duplicated) for the associated display devices (214). For example, primary, mirrored, extended, split-screen, or rotated display modes between computing devices (212) may be possible supported modes. Whatever the mode, the display device (214) being shared between computing devices (212) is rendered at the appropriate scale/resolution for each computing device (212). The agent (434) on each computing device (212) may facilitate convenient and seamless change of display mode (e.g., which display devices (214) are under the control of which computing device (212) and extending or duplicating displays) as selected by a user. This ability to share and re-combine the display devices (214) in different groupings provides for a very rich display populated bridge environment.

In summary, using computing device bridges and methods as described herein may, for example, 1) provide one seamless computing environment that integrates multiple computing environments that have the same or different OS platforms and different program code functionalities; 2) share displays in different modalities; 3) automatically install multi-OS program instructions upon connection to the computing device bridge; 4) provide power for recharging and operating attached peripheral devices and computers; and 5) seamlessly integrates home and work computing environments, peripherals, and IO modalities for ergonomic and efficient workflows. However, it is contemplated that the devices disclosed herein may address other matters and deficiencies in a number of technical areas, for example.

What is claimed is:

1. A computing device bridge, comprising:
a first communication port to establish a connection with a first computing device, the first computing device having a first operating system (OS);
a second communication port to establish a connection with a second computing device having a second OS; and
a controller to:
provide a direct point-to-point connection between the first computing device and the second computing device; and
share a resource of the first computing device or the second computing device with the other of the first computing device and the second computing device.

2. The computing device bridge of claim 1, wherein the resource that is shared comprises:
a memory resource;
a processing resource;
a graphics processing resource;
a display device;
a user input device;
an output device;
program instructions;
an application; or
a combination thereof.

3. The computing device bridge of claim 1, wherein the first communication port and the second communication port comprise:
a wireless communication port;
an ethernet port;
a universal serial bus (USB) port;
a Thunderbolt port; or
a combination thereof.

4. The computing device bridge of claim 1, further comprising a peripheral device port to receive a connector of a peripheral device.

5. The computing device bridge of claim 4, wherein the controller is to share the peripheral device with computing devices with which the computing device bridge has established a connection.

6. The computing device bridge of claim 1:
further comprising a memory device to store an agent to be installed on the first computing device and second computing device to facilitate resource sharing; and
wherein the controller is to, upon connection of the first computing device and the second computing device, transmit the agent to the first computing device and second computing device to be installed.

7. A method, comprising:
establishing a connection between a computing device bridge and a first computing device, the first computing device having a first operating system (OS);
establishing a connection between the computing device bridge and a second computing device having a second OS, wherein the second OS has a different platform than the first OS;
providing a direct point-to-point connection between the first computing device and the second computing device;
sharing resources of the first computing device and the second computing device with one another;
detecting a controlling input device of one of the first or the second computing device to control both the first computing device and the second computing device; and
facilitating user interaction with both computing devices via the controlling input device by converting resource metadata of the computing devices to be compatible with one another.

8. The method of claim 7, further comprising, responsive to user input dragging a file from the first computing device to the second computing device, converting the file into a format compatible with the second computing device.

9. The method of claim 8, wherein conversion is performed by a processor of the first computing device or a processor of the second computing device.

10. The method of claim 8, wherein conversion is performed by a controller of the computing device bridge.

11. The method of claim 7, further comprising authorizing the first computing device and the second computing device as authorized to share resources with one another.

12. The method of claim 7, further comprising syncing files found on the first computing device and the second computing device.

13. A computing device bridge, comprising:
a first communication port to establish a connection with a first computing device, wherein the first computing device has a first operating system (OS);
a second communication port to establish a connection with a second computing device, wherein the second computing device has a second OS that has a different platform than the first OS;
a multiplexer to multiplex display and data signals from the first communication port and the second communication port;
a reflector to identify hardware components coupled to the first computing device and the second computing device; and
a controller to:
provide a direct point-to-point connection between the first computing device and the second computing device;
share resources of one of the first computing device and the second computing device with the other of the first computing device and the second computing device; and
convert resource control data from one of the first and second computing device to be compatible with the other of the first and second computing device.

14. The computing device bridge of claim 13, wherein the first communication port, the second communication port, or a combination thereof provide power to an associated first or second computing device.

15. The computing device bridge of claim 13, wherein the controller is to share the resources of the first computing device and the second computing device based on a historical sharing configuration previously used when the first and second computing devices were coupled to the computing device bridge.
